(19) United States
(12) Patent Application Publication
(10) Pub. No.: US 2026/0276561 A1
(43) Pub. Date: Sep. 17, 2026

(54) THRESHOLD VOLTAGE STABILIZING SYSTEM AND METHOD

(71) Applicant: Varex Imaging Corporation, Salt Lake City, UT (US)

(72) Inventors: Richard Weisfield, Saratoga, CA (US); Steven Freestone, Sandy, UT (US)

(73) Assignee: Varex Imaging Corporation, Salt Lake City, UT (US)

(21) Appl. No.: 19/080,528

(22) Filed: Mar. 14, 2025

(51) Int. Cl. G01N 23/04; G01N 23/083; H04N 25/30; H04N 25/709; H04N 25/78

(52) U.S. Cl. CPC G01N 23/04; G01N 23/083; H04N 25/30; H04N 25/709; H04N 25/78; G01N 2223/501

(57) ABSTRACT

Some embodiments include a detector, comprising: an imaging array including a plurality of pixels and row select lines, each pixel including a transistor coupled to a corresponding one of the row select lines; a row driver coupled to the row select lines; a readout circuit coupled to the imaging array; and a control circuit configured to: operate the pixels during a measurement operation; read signals from the pixels during the measurement operation through the readout circuit; and positively shift threshold voltages of the transistors in response to the signals from the pixels.

Transistors, such as thin film transistors (TFTs) are used in a variety of devices, such as x-ray detectors. Some transistors have threshold voltages that shift over time when turned on. The shift of the threshold voltage may reduce the performance of the device and eventually render the device inoperable.

### BRIEF DESCRIPTION OF SEVERAL VIEWS OF THE DRAWINGS

FIG. 1 is a block diagram of a detector including a threshold voltage stabilizing system according to some embodiments

FIG. 2 is a block diagram of a pixel according to some embodiments.

FIGS. 3A-3C are block diagrams of bias circuits coupled to a pixel of a detector according to some embodiments.

FIG. 4 is a block diagram of compensation capacitors of a detector according to some embodiments.

FIGS. 5-7A are flowcharts of techniques of stabilizing a threshold voltage according to some embodiments.

FIG. 7B is a timing diagram of gate voltages and bias voltages as part of techniques of stabilizing a threshold voltage according to some embodiments.

FIGS. 8-9 are flowcharts of techniques of stabilizing a threshold voltage according to some other embodiments.

FIG. 10 is a block diagram of an x-ray imaging system according to some embodiments.

### DETAILED DESCRIPTION

Embodiments described herein relate to threshold voltages of transistors and, in particular, systems and methods for stabilizing the threshold voltages.

Transistors, such as thin film transistors (TFTs) are used in a variety of applications. In some embodiments, TFTs are used in x-ray detectors. These TFTs may suffer from threshold voltage shifts during operation. In particular, amorphous silicon (a-Si) TFTs may develop a negative threshold voltage shift when the TFTs receive radiation.

Indium gallium zinc oxide (IGZO) TFTs may be used in X-ray detectors due to their much higher mobility and better off characteristics. The improved performance may allow faster switches, lower noise, fewer artifacts, or the like. However, a concern with IGZO TFTs (and metal oxide TFTs in general) is that a negative threshold voltage shift may not be compensated.

Negative threshold-voltage shift caused by radiation in metal oxide TFTs (IGZO in particular) leads to pixels that can no longer turn off. These pixels show up as defects in a detector image, and thus limit the useful life of a detector. Previous work has focused on selecting TFTs with lower TFT Vt shift with radiation, through a combination of material formulation and device design, and using large negative TFT off-voltages in order to accommodate these shifts.

Positive bias temperature stress (PBTS) is a phenomenon in IGZO TFTs, with Vt shifting according to a power law of approximately t^0.3 in time. Embodiments described herein include techniques to detect a negative threshold shift and compensate at least in part the negative threshold shift.

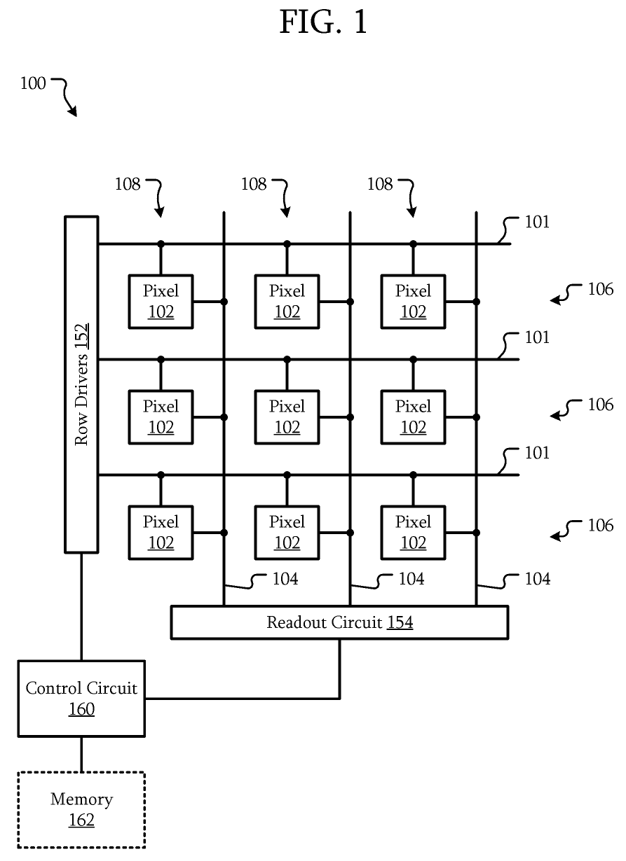

FIG. 1 is a block diagram of a detector including a threshold voltage stabilizing system according to some embodiments. The detector 100 includes pixels 102 arranged in rows 106 and columns 108. The rows 106 and columns 108 of pixels 102 may form an imaging array. The pixels 102 each include at least one transistor having a threshold voltage that may shift due to radiation. Although a 3 x 3 detector is illustrated as an example, in other examples, the detector can be an m x n with m rows and n columns where m and n are integers that may be the same or different.

The pixels 102 are coupled to row drivers 152 through the row select lines 101. The pixels 102 are configured to be selectively coupled to the column lines 104 in response to signals on the row select lines 101. Although row select lines 101 have been used as an example of control lines coupled between the pixels 102 and the row drivers 152, the row drivers 152 may include other control lines. In some embodiments, the row drivers 152 may be configured to singularly activate the row select lines 101, simultaneously activate two or more of the row select lines 101, and/or simultaneously activate all of the row select lines 101. In some embodiments, the activation of the one or more row select lines 101 may include different voltages during different conditions, as will be described in further detail below.

The column lines 104 are coupled to readout circuit 154. The readout circuit 154 may include circuitry configured to read output signals from a row of pixels 102 when those pixels 102 are coupled to the column lines 104. The readout circuit 154 may also be configured to aggregate the outputs from rows 106 of the pixels 102 into a frame. The readout circuit 154 is an example of circuitry that may be used to generate frames, images, or the like from the pixels 102.

Control circuit 160 is configured to control the row drivers 152 and readout circuit 154. The control circuit 160 may include a processor that may be a general-purpose processor, a digital signal processor (DSP), an application specific integrated circuit, a microcontroller, a programmable logic device (e.g., field-programmable gate array [FPGA]), discrete circuits, a combination of such devices, or the like. The control circuit 160 may include internal portions, such as registers, cache memory, processing cores, or the like, and may also include external interfaces, such as address and data bus interfaces, interrupt interfaces, or the like. Multiple processors may be present. In addition, other interface devices, such as logic chipsets, hubs, memory controllers, communication interfaces, or the like may be part of the control circuit 160 to connect the control circuit 160 to and/or control the row drivers 152 and readout circuit 154. The control circuit 160 may include other circuitry to connect to other internal and external components.

As will be described if further detail below, a variety of circuits and techniques may be used to detect a negative threshold voltage shift. Various circuits will be described, followed by description of various operations.

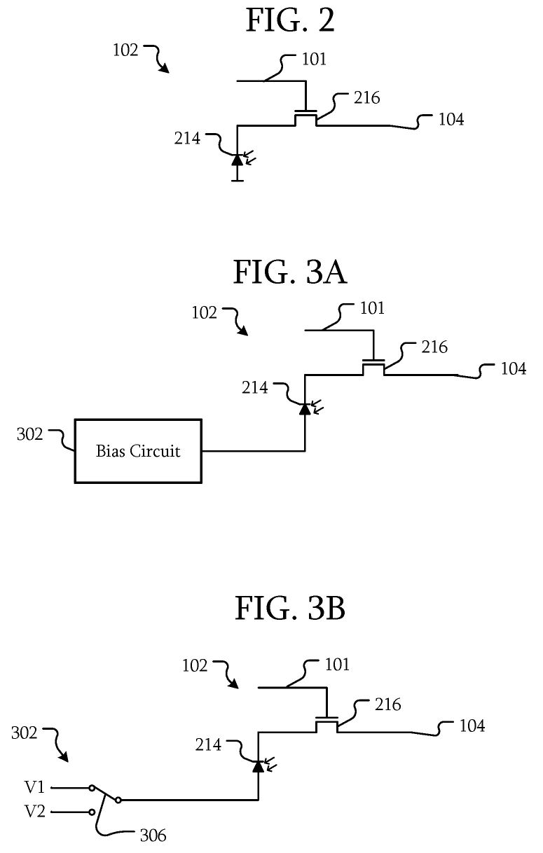

FIG. 2 is a block diagram of a pixel according to some embodiments. Referring to FIGS. 1 and 2, the pixel 102 is an example of the pixel 102 of the detector 100 of FIG. 1. The pixel 102 may include a sensor 214, such as a photodiode, coupled to a transistor 216. The transistor 216 may be a metal oxide transistor such as an indium gallium zinc oxide (IGZO) thin film transistor (TFT). The IGZO TFT is a transistor that includes an IGZO layer or material. However, the transistor 216 may include any transistor that has a threshold voltage that may drift negatively during operation, such as being changed by exposure to radiation, and may be positively shifted through applied stress.

Although a single transistor 216 is illustrated, the pixel 102 may include multiple transistors identical to transistor 216, one or more other transistors similar to transistor 216, transistors formed of similar materials, transistors formed by other processes or with other materials, or the like. Although a particular example of a pixel is illustrated in FIG. 2, in other embodiments, the pixel 102 may have a different configuration, different transistors, different control signals, different outputs, or the like. For example, although a 1T transistor pixel 102 is illustrated, in other embodiments the pixel 102 may be a 3T pixel, a 4T pixel, or other pixel architectures including a transistor 216 or similar transistors.

The transistor 216 may be responsive to a signal on a control line such as row select line 101 (e.g., provided by row drivers 152). A pixel 102 may be configured to output a signal from the sensor 214 to an output line such as the column line 104, which may be processed by the read-out circuit 154.

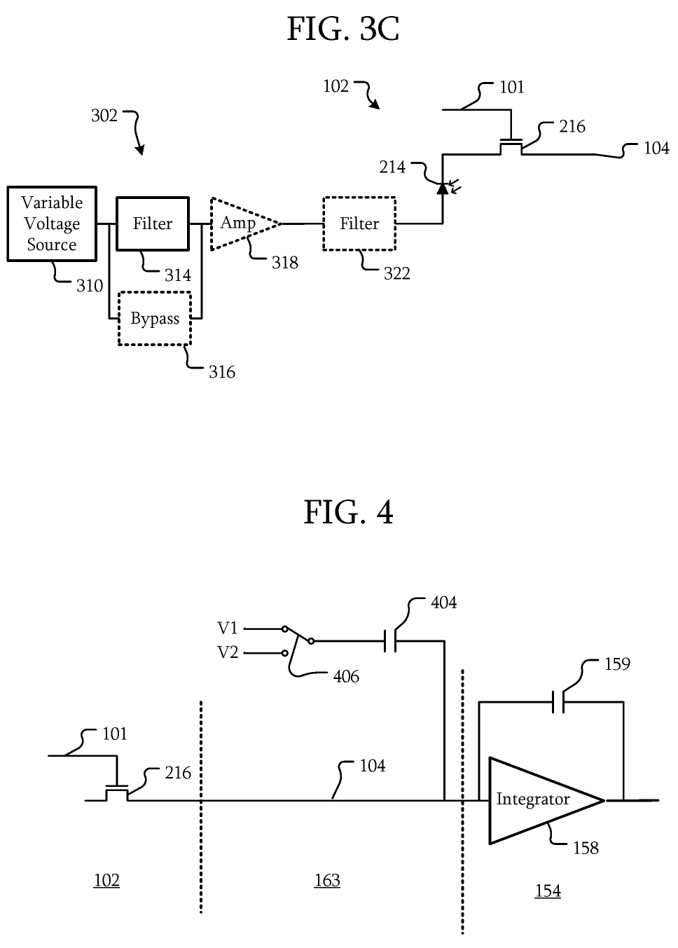

FIGS. 3A-3C are block diagrams of bias circuits coupled to a pixel of a detector according to some embodiments. Referring to FIGS. 1 and 3A, in some embodiments, a bias circuit 302 is coupled to the pixel 102. The bias circuit 302 is configured to apply a bias voltage to sensors of the pixel 102, such as the sensor 214. The bias circuit 302 may be coupled to each of the pixels 102. Alternatively, each of the pixels 102 may be coupled to a dedicated bias circuit 302.

Referring to FIGS. 1 and 3B, in some embodiments, the bias circuit 302 may include a switch 306 configured to switch between different bias voltages. For example, two bias voltages V1 and V2 are illustrated. In other embodiments, the switch 306 may be configured to switch between more than two voltages.

Although a switch 306 has been used as an example of a bias circuit 302 that may output different voltages, different circuits may be used to output different voltages. For example, a digital to analog converter (DAC), a resistor network with one or more variable resistors, or the like may be used to controllably generate different voltages.

Referring to FIGS. 1 and 3C, in some embodiments, the bias circuit 302 may include a variable voltage source 310 and a filter 314 configured to filter the bias voltage. The variable voltage source 310 may be configured to controllably generate different voltages. For example, during normal operation, a relatively stable bias voltage may be used; however, during a test operation as will be described in further detail below when a threshold voltage of the transistor 212 is determined, a different bias voltage may be used.

The bias voltage may be changed to that different bias voltage relatively quickly. To accommodate the quick change, a different character of filtering may be used. For example, in normal operation, the voltage from the variable voltage source 310 may be filtered by the filter 314 to create a desired stability in the bias voltage for the pixel 102. However, to accommodate a quick change to a different bias voltage the filter 314 may be bypassed by the bypass circuit 316. The bypass circuit 316 may be configured to selectively bypass the filter 314. By bypassing the filter 314, the frequency response of the effective filtering may be changed, allowing for faster changes.

In some embodiments, the filter 314 may include a variable resistor. The variable resistor may form at least part of the filter 314 with the bulk capacitance. The amount of filtering, the frequency response, or the like may be changed by changing the variable resistor. For example, for a faster response, the variable resistor may be set to a lower resistance and for a slower more stable response, the variable resistor may be set to a higher resistance. Thus, in some embodiments, the bypass circuit 316 may be omitted, the functionality incorporated into the filter 314, or the like.

In some embodiments, the bias circuit 302 may further include an amplifier 318. The amplifier 318 is configured to amplify and/or buffer the output of the filter 314. The output of the amplifier 318 may be applied as the bias voltage for the pixels 102 or may be further filtered by filter 322.

FIG. 4 is a block diagram of compensation capacitors of a detector according to some embodiments. Referring to FIGS. 1 and 4, a substrate 163 including the pixels 102 and/or the readout circuit 154 may also include one or more compensation capacitors 404. The compensation capacitor 404 may be coupled to the column lines 104. Different regions, devices, or the like of the detector 100 are separated by dashed lines. An integrator 158 as part of the readout circuit 154 may integrate the signal on the column line 104.

The compensation capacitor 404 may be used to inject or remove charge to cancel the parasitic charge. The compensation capacitor 404 and voltage level may be selected to match the parasitic charge and cancel it out, while maintaining a dark image level that is not clipped. The amount of parasitic charge changes as the transistor 216 threshold drifts. By monitoring this average dark image levels the amount of drift can be calculated.

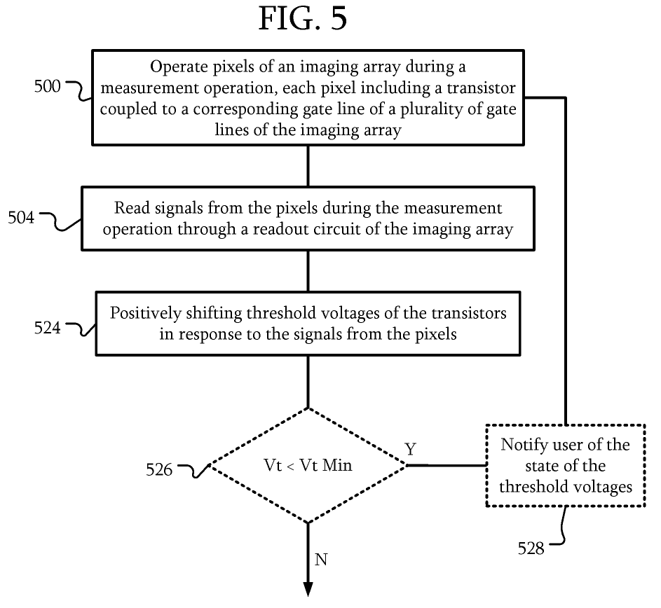

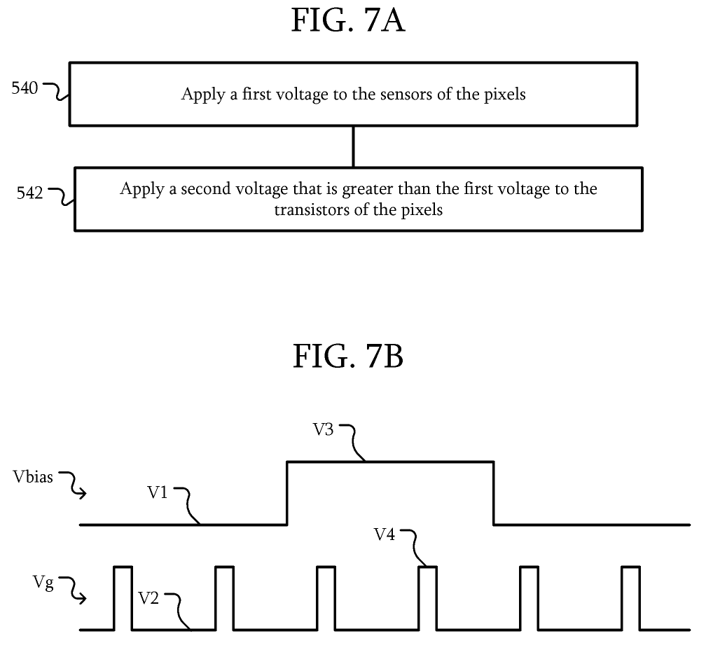

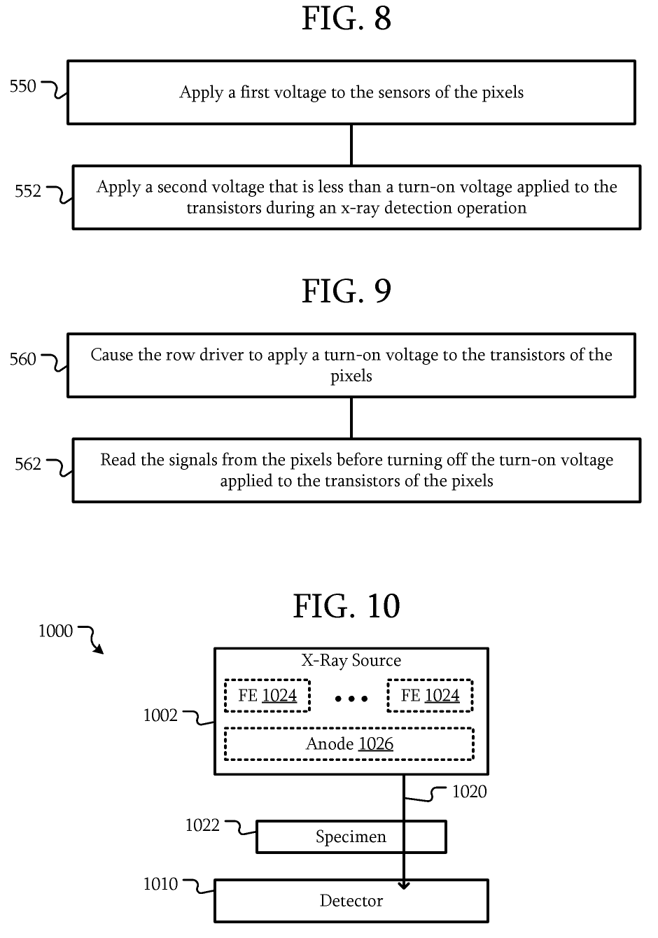

FIGS. 5-7A are flowcharts of techniques of stabilizing a threshold voltage according to some embodiments. FIG. 7B is a timing diagram of gate voltages and bias voltages as part of techniques of stabilizing a threshold voltage according to some embodiments. FIGS. 8-9 are flowcharts of techniques of stabilizing a threshold voltage according to some other embodiments. Referring to FIGS. 1 and 5, the detector 100 of FIG. 1 will be used as an example. In 500, the pixels 102 are operated during a measurement operation. In 504, signals from the pixels 102 are read during the measurement operation by the readout circuit 154. The measurement operation may be performed in the absence of x-rays. In 524, the threshold voltages of the transistors 216 of the pixels 102 are positively shifted in response to the signals from the pixels 102 read during the measurement operation.

In some embodiments, the threshold voltages of the transistors 216 of the pixels 102 may be shifted by turning on the row select lines 101. Turning on the row select lines 101 may positively shift the threshold voltages of the transistors 216. In particular, when a voltage that is greater than a turn-on voltage applied to the transistors during an x-ray detection operation other than in the measurement operation, the threshold voltage may shift.

The shifting may be an intrinsic property of the transistors 216, such as in IGZO transistors 216 to counteract negative shift. In some embodiments, the transistor 216 threshold voltage is shifted into a more useful range that fits within available voltage parameters and potentially extends the maximum radiation level the transistors 216 can be exposed to. That is, a negative shift due to exposure may be counteracted, allowing the transistors 216 to be exposed to more radiation.

In some embodiments, the operations in 500, 504, and 524 may be performed at a variety of times and after a variety of conditions. For example, the control circuit 160 may store a schedule for when to perform the measurement operation. The measurement operation may be performed during a scheduled downtime for the detector 100. The measurement operation may be performed over a relatively short period of time between images or frames captured by the detector 100. The measurement operation may be performed after every frame or image captured by the detector 100. In some embodiments, the operations may be performed in a relatively short period of time, such as about 1 millisecond (ms), 10 ms, 100 ms, or the like. The length of time may be selected so that any interruption in imaging is not noticeable by a user. In some embodiments, the relatively short, but frequently repeated operation may counteract applications with higher dose rates. For example, the detector 100 may be exposed to higher energy x-rays that are absorbed less by a scintillator. As a result, the transistors 216 may be exposed to more, higher energy x-rays, causing the threshold voltages to shift more over time. The periodic shifting and/or the shifting after every exposure may reduce and/or counteract the shift due to the higher energy x-rays. This may allow the detector 100 to be used in higher energy applications with a longer lifetime.

In some embodiments, the measurement and shifting may occur after the detector 100 receives a particular dose. For example, the detector 100 may include devices configured to measure dose. The pixels 102 may be used to measure the dose, a separate dosimeter may be integrated with the detector 100, the detector 100 may be configured to receive a measurement of the dose from an external dosimeter, or the like. When the dose exceeds a threshold, the measurement and shifting in 500, 504, and 524 may be performed.

In some embodiments, the positive shifting of the threshold voltages of the transistors in 524 may be an amount to return the threshold voltage to a desired value or range of values. The operations in 500, 504, and 524 may be performed repeatedly until the shift of the threshold voltages are at the desired value or within the desired range of values. Alternatively, a single instance of positively shifting the may shift the threshold voltages into the desired range or to the desired value.

In other embodiments, the amount of shifting of the threshold voltages in 524 may be less than a desired amount. The operations may not be immediately repeated. The operations 500, 504, and 524 may be repeated at a later time. However, as the operations are repeated at a later time, the threshold voltages of the transistors 216 may be shifted to the desired value or range over time. That is, the amount of positive shift accumulated over a given time period may be greater than any amount of negative shift over the same time period. In one example, a detector 100 continuously exposed to x-rays at a dose rate of about 2 Rad per hour over a period of 6 months may have a negative threshold voltage shift of about -1.2 V. A positive bias of 16V applied to the transistors 212 of the detector 100 for 1 hour may shift the threshold voltages positively by about 1 V.

In some embodiments, the control circuit 160 is configured to positively shift the threshold voltages of the transistors 216 by applying a first voltage to the transistors. That first voltage may be greater than a turn-on voltage applied to the transistors 216 during an x-ray detection operation different from the measurement operation. The row drivers may be configurable to generate the different voltages to by applied through the row lines 101.

In some embodiments, in 526, the threshold voltage is compared with a minimum threshold voltage Vt Min. The comparison of the threshold voltage may be a comparison of the threshold voltage of each of the transistors 216 to the minimum threshold voltage. Alternatively, the comparison may include a comparison of the threshold voltage of an average of a group of the transistors 216, an average of all of the transistors 216, or the like. If the threshold voltage or voltages are less than the minimum, the operations in 500, 504, and 524 may be performed until the threshold voltage or voltages are no longer less than the minimum.

In some embodiments, the positive shifting of the threshold voltages in 524 may be omitted. Rather, the signals read from 500 and 504 may be used as an indication of a trend towards the end of life of the detector. For example, rather than repeating 500 and 504, the user may be notified of the state of the threshold voltages in 528. The notification in 528 may also be in addition to the shifting of the threshold voltages in 524.

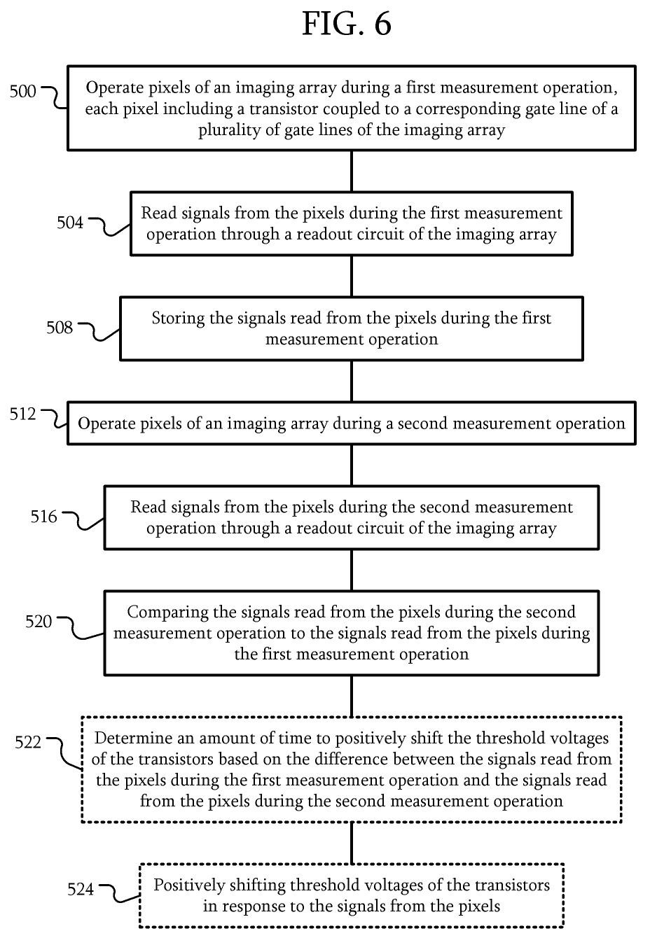

Referring to FIGS. 1 and 6, in some embodiments, the signals from the pixels are aggregated into an image. The image may be compared to a calibration image to determine whether the threshold voltages have shifted. The calibration image may be generated in the same technique to create a reference point when the threshold voltages of the transistors 216 are within an acceptable range. As a result, any change in the threshold voltages may be determined based on a difference between the calibration image and the recently acquired signals or image from the pixels.

For example, in 500, the pixels 102 of the detector 100 may be operated during a first measurement operation as described above with respect to FIG. 5. Signals from the pixels 102 may be read in 504 as described above. In 508, the signals read from the pixels 102 during the first measurement operation are stored in memory 162. These stored signals 508 may form the calibration image described above.

In 512, the pixels 102 may be operated during a second measurement operation at a later time. Signals are read from the pixels 102 during the second measurement operation in 516. The operation in 512 and reading in 516 may be similar or identical to the operation in 500 and the reading in 504.

The signals read during the first measurement operating in 504 are compared with the signals read during the second measurement operation in 516. A difference in the two sets of signals may be used to positively shift the threshold voltages of the transistors 216. For example, if the difference is greater than a threshold amount, indicating that the threshold voltages have shifted significantly, the threshold voltages may be shifted in 524. If the difference is less than the threshold, the shifting of the threshold voltages in 524 may be omitted or postponed to a later time.

In some embodiments, the positively shifting in 524 may be performed in other ways based on the difference in the signals read in 504 and 516. For example, in 522, an amount of time to positively shift the threshold voltages may be determined based on the difference in the signals read in 504 and 516.

In some embodiments, the amount of time to positively shift the threshold voltages based on the difference between the signals read in 504 and 516 may be applied in different ways. In one example, the threshold voltages of each of the transistors 216 may be shifted the same amount.

In another example, the amount of time of the shifting may be performed on a row by row basis. For example, for each of the row select lines 101, the amount of time to shift the threshold voltages of the transistors associated with the particular row select line 101 may be determined independently. In some embodiments, the shifting may be performed substantially simultaneously, with the beginning of the shifting occurring at the same time. However, the end of the shifting for each row 106 may be different, depending on the associated time. In other embodiments, the shifting may occur row by row.

In some embodiments, rather than on an individual row by row basis, the time to shift the threshold voltages may be determined on groups of rows 106, such as adjacent groups of rows 106. The different groups of rows 106 may be shifted similar to the different rows 106 as described above.

In some embodiments, the compensation for any negative shift may be performed at the pixel 102 level. The threshold voltage of each pixel 102 may be shifted by a different amount based on the associated difference between the signals.

In some embodiments, the negative shift in the threshold voltages may be non-uniform due to the non-uniform exposure to radiation. The difference in the treatment of different rows 106, groups of rows 106, pixels 102, or the like described above may accommodate at least some of the non-uniformity. However, in some embodiments, the characteristics of the transistors 216 may alleviate at least some of the non-uniformity. For example, the positive shifting of the threshold voltages over time for a given positive bias may be non-linear. The rate of shift may be larger initially and taper off over time. The rate of shift may also be dependent on the magnitude of the negative shift.

Referring to FIGS. 1, 3A-3C and 7A, operations 540 and 542 may be part of operations 500 and 512 described above. During the measurement operation, in 540, a first voltage is applied to the sensors 214. In some embodiments the bias circuit 302 is configured to apply a negative voltage as the first voltage to the sensors 214 of the pixels 102. In 542, a second voltage that is greater than the first voltage is applied to the transistors 216 of the pixels 102. The second voltage may be a negative voltage, but still greater than the first negative voltage. The second negative voltage may be less than a turn on voltage for the transistor applied to the transistors 216 during a normal readout operation associated with an exposure.

In a particular example, the first voltage may be a voltage of -8V. The second voltage may be set to a higher voltage such as -5V. The second voltage may be selected to be a voltage at which the transistor 216 may normally leak, reducing a charge signal from the pixel 102. As the threshold voltage of the transistor 216 shifts negatively, the amount of leakage current increases, changing the charge signal. The signals read from the pixels 102 during this state are therefore associated with the shift in the threshold voltages.

Referring to FIGS. 1, 3A-3C, and 7B, in some embodiments, the voltages described above may be applied in a particular sequence with other voltages. Here, the bias voltage Vbias and the gate votlage Vg are illustrated where V1 is the first voltage and V2 is the second voltage. For example, the bias voltage V1 may be set to the first voltage V1, such as -8V. A number of frames may be read out where the gate voltage Vg of the transistors 216 is nominally held at the second voltage V2 of -5V and set to a higher voltage V4, such as 15V, to read out the pixels. After the number of frames, the bias voltage Vbias may be set to a higher voltage V3, such as 0V. A number of frames may be read out until the pixels stabilize. After the pixels stabilize, the bias voltage Vbias may be stepped from 0V to -8V while the gate voltage Vg is V2, -5V. When the bias voltage Vbias switches to the first voltage V1, -8V, the transistors 216 may leak. The pixels 102 may be read out one more time after the transition of the bias voltage Vbias to -8V. That read out operation may indicate how much charge remains on the pixels 102. As the gate voltage Vg is V2, -5V, while the bias voltage Vbias transitions to -8V, some amount would leak through the transistors 216. A more negative gate voltage Vg may not allow the transistors 216 to leak; however, the higher volage may allow the transistors 216 to leak. As the second voltage V2 that is used increases, the amount of leakage may increase, resulting in a measurable loss of charge.

In some embodiments, a similar operation may be performed but the bias voltages Vbias may be different and the gate voltages may be stepped. For example, the first voltage V1 may be set to about -6V. A number of frames may be read out, waiting for the pixels 102 to stabilize. Then, the first voltage V1 may be stepped to a higher voltage, such as a step to about -5.8V. The result is an injection of about -0.2V of charge on the pixels 102. The first frame read out after that step measures how much charge is transferred from the pixels 102. This process may be repeated for a series of gate voltages Vg during the read out. For example, the gate voltages Vg may begin at about 16V and stepped lower while repeating the above operation. At the higher gate voltage Vg, the transistors 216 have such a high conductance that all or substantially all of the charge is read out of the pixels 102. As the gate voltages Vg are lowered, such as to about 3V to 8V, the conductance of the transistors 216 may limit the charge transferred during the read out. This may result in a measurement that shows when the transistors 216 begin to turn on.

Referring to FIGS. 1, 3A-3C and 8, in some embodiments, operations 550 and 552 may be part of operations 500 and 512 described above. A first voltage may be applied to the sensors of the pixels in 550. This first voltage may inject a positive charge on the pixels. A second voltage may be applied to the pixels by the row driver 152 in 552. The second voltage may be less than a turn-on voltage applied to the transistors during an x-ray detection operation different from the measurement operation. In a particular example, the second voltage may be selected to be about an expected threshold voltage. In other examples, the second voltage may be selected to be about a threshold voltage that if the threshold voltage of the transistor 216 shifts more negatively would impact the quality of an image during the normal imaging operation. Although some examples have been given for the second voltage, in other embodiments, the second voltage may be different but still less than the normal turn-on voltage.

As a result, some of the charge injected on the pixels 102 may be partially read out. The amount read out may be based on the shift in the threshold voltage. That is as the threshold voltage shifts more negatively, the applied second voltage is effectively higher, resulting in more charge transferred from the pixels 102. Thus, the signals read from the pixels are representative of the shift of the threshold voltages.

Referring to FIGS. 1, 4, and 9, operations 560 and 562 may be part of operations 500 and 512 described above. In 560, the row drivers 152 are configured to apply a turn-on voltage to the transistors of the pixels. In 562, the signals from the pixels are read before turning off the turn-on voltage applied to the transistors 216 of the pixels. The resulting signals is dependent on the capacitance of the transistors. These signals will shift as the threshold voltages shift.

In some embodiments, the operations in 560 and 562 may not need additional hardware. That is, the operations may be performed on existing detector 100 by using different software, firmware, or the like to operate the detector 100 differently. Reading pixels 102 in a normal operation is not performed in this manner as the operation injects an error into the signals that would otherwise be cancelled out by turning off the turn-on voltage before reading the signals. That is, an otherwise detrimental aspect of operation may be used to obtain a benefit of determining a shift in threshold voltages.

In some embodiments, the row drivers 152 for the rows 106 are disabled at the beginning of row readout. An integrator 158 that is part of the readout circuit 154, such as that of FIG. 4, is reset. All transistors 216 are turned off. A reset sample is taken by the readout circuit 154 in this state. In some embodiments, the filtering of a bias voltage from the bias circuit 302 may be more filtered.

After the reset sample is acquired, the row driver 152 for a particular row 106 is enabled. The compensation capacitor 404 may be switched off by switching switch 406 to compensate the charge. A signal sample may then be taken. The compensation capacitor 404 and voltage levels may be selected to match and cancel out parasitic charge while maintaining a dark image level that is not clipped. However, the amount of parasitic charge may change as the threshold voltage shifts. Thus, the read value provides an indication of the threshold voltage shift. That is, with a fixed compensation capacitance and voltage, the change in threshold voltage will result in a change in the signal sample. In some embodiments, one or more feedback capacitors 159 of the integrator 158 may be switched out, set to a lower level, or the like when acquiring signals to measure the threshold voltage shifts. The lower feedback capacitance may make the integrator 158 more sensitive to charge levels.

In other embodiments, an additional voltage is applied to the row lines 101 in addition to a high voltage to enable a transistor 216 and a low voltage to disable the transistor 216. In particular, a more negative voltage, lower than the low voltage may be applied to rows 106 other than the active row 106.

For example, an integrator 158 that is part of the readout circuit 154 is reset. All transistors 216 are turned off by applying the low voltage. A reset sample is taken by the readout circuit 154 in this state. However, when one row 106 is activated by applying the high voltage to the associated row line 101, the other row lines 101 are driven by the row drivers 152 to the more negative voltage.

The voltage change between the low voltage and the more negative voltage causes a small amount of charge from each inactive transistor 216 to be injected onto the column lines 104. The sum of all the transistor 216 charges is used to compensate for the charge injected by turning on the active row’s transistor 216.

FIG. 10 is a block diagram of an x-ray imaging system according to some embodiments. The x-ray detector 1000 includes an x-ray source 1002 and detector 1010. The detector 1010 may include detector 100 or the like as described above. In some embodiments, the x-ray source 1002 includes multiple field emitters (FE) 1024. Electron beams from the field emitters 1024 may be directed towards an anode 1026 to generate x-rays 1020. The x-ray source 1002 is disposed relative to the detector 1010 such that x-rays 1020 may be generated to pass through a specimen 1022 and detected by the detector 1010. In some embodiments, the detector 1010 is part of a medical imaging system. In other embodiments, the x-ray detector 1000 may include a portable vehicle scanning system as part of a cargo scanning system. The x-ray detector 1000 may be any system that may include an x-ray detector.

Some embodiments include a detector 100, 1010, comprising: an imaging array including a plurality of pixels 102 and row select lines 101, each pixel 102 including a transistor 216 coupled to a corresponding one of the row select lines 101; a row driver 152 coupled to the row select lines 101; a readout circuit 154 coupled to the imaging array; and a control circuit 160 configured to: operate the pixels 102 during a measurement operation; read signals from the pixels 102 during the measurement operation through the readout circuit 154; and positively shift threshold voltages of the transistors 216 in response to the signals from the pixels 102.

In some embodiments, the control circuit 160 is further configured to positively shift the threshold voltages of the transistors 216 comprises applying a first voltage to the transistors 216; and the first voltage is greater than a turn-on voltage applied to the transistors 216 during an x-ray detection operation different from the measurement operation.

In some embodiments, the detector 100, 1010 further comprises a memory 162; wherein the control circuit 160 is further configured to: store the signals read from the pixels 102 during a first measurement operation; compare the signals read from the pixels 102 during a second measurement operation; and positively shift the threshold voltages of the transistors 216 in response to a difference between the signals read from the pixels 102 during the first measurement operation and the signals read from the pixels 102 during the second measurement operation.

In some embodiments, the control circuit 160 is further configured to: positively shift the threshold voltages of the transistors 216 in response to the difference between the signals read from the pixels 102 during the first measurement operation and the signals read from the pixels 102 during the second measurement operation multiple times before reading signals from the pixels 102 during a third measurement operation.

In some embodiments, the control circuit 160 is further configured to: determine an amount of time to positively shift the threshold voltages of the transistors 216 based on the difference between the signals read from the pixels 102 during the first measurement operation and the signals read from the pixels 102 during the second measurement operation.

In some embodiments, the control circuit 160 is further configured to: for each of the row select lines 101, determine an amount of time to positively shift the threshold voltages of the transistors 216 of pixels 102 associated with the row select line 101 based on the difference between the signals read from the pixels 102 associated with the row select line 101 during the first measurement operation and the signals read from the pixels 102 associated with the row select line 101 during the second measurement operation.

In some embodiments, the control circuit 160 is further configured to: for each of the pixels 102 , determine an amount of time to positively shift the threshold voltage of the transistor 216 of the pixel 102 based on the difference between the signals read from the pixel 102 during the first measurement operation and the signal read from the pixel 102 during the second measurement operation.

In some embodiments, the memory 162 is configured to store a schedule for measurement operations; and the control circuit 160 is further configured to perform the measurement operation according to the schedule.

In some embodiments, the detector 100, 1010 further comprises a bias circuit 302 coupled to the pixels 102 and configured to apply a bias voltage to sensors 214 of the pixels 102; wherein: the control circuit 160 is further configured to, during the measurement operation: cause the bias circuit 302 to apply a first negative voltage as the bias voltage to the sensors 214 of the pixels 102; and cause the row driver 152 to apply a second negative voltage to the transistors 216 of the pixels 102; and the second negative voltage is greater than the first negative voltage.

In some embodiments, the detector 100, 1010 further comprises a bias circuit 302 coupled to the pixels 102 and configured to apply a bias voltage to sensors 214 of the pixels 102; wherein: the control circuit 160 is further configured to, during the measurement operation: cause the bias circuit 302 to apply a first voltage as the bias voltage to the sensors 214 of the pixels 102; and cause the row driver 152 to apply a second voltage to the transistors 216 of the pixels 102; and the second voltage is less than a turn-on voltage applied to the transistors 216 during an x-ray detection operation different from the measurement operation.

In some embodiments, the detector 100, 1010 further comprises a bias circuit 302 coupled to the pixels 102 and configured to apply a bias voltage to sensors 214 of the pixels 102; and a filter configured to filter the bias voltage; and a bypass circuit configured to selectively bypass the filter.

In some embodiments, the control circuit 160 is further configured to, during the measurement operation: cause the row driver 152 to apply a turn-on voltage to the transistors 216 of the pixels 102; and read the signals from the pixels 102 before turning off the turn-on voltage applied to the transistors 216 of the pixels 102.

Some embodiments include a method, comprising: operating pixels 102 of an imaging array during a measurement operation, each pixel 102 including a transistor 216 coupled to a corresponding row select line 101of a plurality of row select lines 101 of the imaging array; reading signals from the pixels 102 during the measurement operation through a readout circuit 154 of the imaging array; and positively shifting threshold voltages of the transistors 216 in response to the signals from the pixels 102.

In some embodiments, operating the pixels 102 of the imaging array during the measurement operation comprises: applying a first voltage to sensors 214 of the pixels 102; and applying a second voltage to the transistors 216 of the pixels 102; wherein the second voltage is greater than the first voltage.

In some embodiments, operating the pixels 102 of the imaging array during the measurement operation comprises: applying a first voltage to sensors 214 of the pixels 102; and applying a second voltage to the transistors 216 of the pixels 102; wherein the second voltage is less than a turn-on voltage applied to the transistors 216 during an x-ray detection operation different from the measurement operation.

In some embodiments, operating the pixels 102 of the imaging array during the measurement operation comprises: applying a turn-on voltage to the transistors 216 of the pixels 102; and reading the signals from the pixels 102 during the measurement operation before turning off the turn-on voltage applied to the transistors 216 of the pixels 102.

In some embodiments, positively shifting threshold voltages of the transistors 216 comprises: applying a first voltage to the transistors 216 of the pixels 102; wherein the first voltage is greater than a turn-on voltage applied to the transistors 216 during an x-ray detection operation different from the measurement operation.

In some embodiments, the measurement operation is a first measurement operation; and the method further comprises: storing the signals read from the pixels 102 during the first measurement operation; operating the pixels 102 of the imaging array during a second measurement operation; reading signals from the pixels 102 during the second measurement operation through the readout circuit 154 of the imaging array; and comparing the signals read from the pixels 102 during the second measurement operation to the signals read from the pixels 102 during the first measurement operation; and positively shifting the threshold voltages of the transistors 216 in response to a difference between the signals read from the pixels 102 during the first measurement operation and the signals read from the pixels 102 during the second measurement operation.

In some embodiments, positively shifting the threshold voltages of the transistors 216 in response to the difference between the signals read from the pixels 102 during the first measurement operation and the signals read from the pixels 102 during the second measurement operation comprises positively shifting the threshold voltages of the transistors 216 multiple times before reading signals from the pixels 102 during a third measurement operation.

Some embodiments include a system, comprising: an x-ray source configured to generate x-rays; a detector 100, 1010 disposed to receive the x-rays, the detector 100, 1010 comprising: an imaging array including a plurality of pixels 102 and row select lines 101, each pixel 102 including a transistor 216 coupled to a corresponding one of the row select lines 101; a row driver 152 coupled to the row select lines 101; a readout circuit 154 coupled to the imaging array; and a control circuit 160 configured to: operate the pixels 102 during a measurement operation; read signals from the pixels 102 during the measurement operation through the readout circuit 154; and positively shift threshold voltages of the transistors 216 in response to the signals from the pixels 102.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

\The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent FIG. 1, FIG. 4 can depend from either of FIGS. 1 and 3, with these separate dependencies yielding two distinct embodiments; FIG. 5 can depend from any one of FIGS. 1,3, or 4, with these separate dependencies yielding three distinct embodiments; FIG. 6 can depend from any one of FIGS. 1,3,4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

1. A detector, comprising:
an imaging array including a plurality of pixels and row select lines, each pixel including a transistor coupled to a corresponding one of the row select lines;a row driver coupled to the row select lines;a readout circuit coupled to the imaging array; anda control circuit configured to:operate the pixels during a measurement operation;read signals from the pixels during the measurement operation through the readout circuit; andpositively shift threshold voltages of the transistors in response to the signals from the pixels.

2. The detector of claim 1, wherein:
the control circuit is further configured to positively shift the threshold voltages of the transistors comprises applying a first voltage to the transistors; andthe first voltage is greater than a turn-on voltage applied to the transistors during an x-ray detection operation different from the measurement operation.

3. The detector of claim 1, further comprising:
a memory;wherein the control circuit is further configured to:store the signals read from the pixels during a first measurement operation;compare the signals read from the pixels during a second measurement operation; andpositively shift the threshold voltages of the transistors in response to a difference between the signals read from the pixels during the first measurement operation and the signals read from the pixels during the second measurement operation.

4. The detector of claim 3, wherein the control circuit is further configured to:
positively shift the threshold voltages of the transistors in response to the difference between the signals read from the pixels during the first measurement operation and the signals read from the pixels during the second measurement operation multiple times before reading signals from the pixels during a third measurement operation.

5. The detector of claim 3, wherein the control circuit is further configured to:
determine an amount of time to positively shift the threshold voltages of the transistors based on the difference between the signals read from the pixels during the first measurement operation and the signals read from the pixels during the second measurement operation.

6. The detector of claim 5, wherein the control circuit is further configured to:
for each of the row select lines, determine an amount of time to positively shift the threshold voltages of the transistors of pixels associated with the row select line based on the difference between the signals read from the pixels associated with the row select line during the first measurement operation and the signals read from the pixels associated with the row select line during the second measurement operation.

7. The detector of claim 5, wherein the control circuit is further configured to:
for each of the pixels, determine an amount of time to positively shift the threshold voltage of the transistor of the pixel based on the difference between the signals read from the pixel during the first measurement operation and the signal read from the pixel during the second measurement operation.

8. The detector of claim 3, wherein:
the memory is configured to store a schedule for measurement operations; andthe control circuit is further configured to perform the measurement operation according to the schedule.

9. The detector of claim 1, further comprising:
a bias circuit coupled to the pixels and configured to apply a bias voltage to sensors of the pixels;wherein: the control circuit is further configured to, during the measurement operation: cause the bias circuit to apply a first negative voltage as the bias voltage to the sensors of the pixels; andcause the row driver to apply a second negative voltage to the transistors of the pixels; and

10. The detector of claim 1, further comprising:
a bias circuit coupled to the pixels and configured to apply a bias voltage to sensors of the pixels;wherein: the control circuit is further configured to, during the measurement operation: cause the bias circuit to apply a first voltage as the bias voltage to the sensors of the pixels; andcause the row driver to apply a second voltage to the transistors of the pixels; and

11. The detector of claim 1, further comprising:
a bias circuit coupled to the pixels and configured to apply a bias voltage to sensors of the pixels; anda filter configured to filter the bias voltage; anda bypass circuit configured to selectively bypass the filter.

12. The detector of claim 1, wherein the control circuit is further configured to, during the measurement operation:
cause the row driver to apply a turn-on voltage to the transistors of the pixels; andread the signals from the pixels before turning off the turn-on voltage applied to the transistors of the pixels.

13. A method, comprising:
operating pixels of an imaging array during a measurement operation, each pixel including a transistor coupled to a corresponding row select line of a plurality of row select lines of the imaging array;reading signals from the pixels during the measurement operation through a readout circuit of the imaging array; andpositively shifting threshold voltages of the transistors in response to the signals from the pixels.

14. The method of claim 13, wherein operating the pixels of the imaging array during the measurement operation comprises:
applying a first voltage to sensors of the pixels; andapplying a second voltage to the transistors of the pixels;wherein the second voltage is greater than the first voltage.

15. The method of claim 13, wherein operating the pixels of the imaging array during the measurement operation comprises:
applying a first voltage to sensors of the pixels; andapplying a second voltage to the transistors of the pixels;wherein the second voltage is less than a turn-on voltage applied to the transistors during an x-ray detection operation different from the measurement operation.

16. The method of claim 13, wherein operating the pixels of the imaging array during the measurement operation comprises:
applying a turn-on voltage to the transistors of the pixels; andreading the signals from the pixels during the measurement operation before turning off the turn-on voltage applied to the transistors of the pixels.

17. The method of claim 13, wherein positively shifting threshold voltages of the transistors comprises:
applying a first voltage to the transistors of the pixels;wherein the first voltage is greater than a turn-on voltage applied to the transistors during an x-ray detection operation different from the measurement operation.

18. The method of claim 13, wherein:
the measurement operation is a first measurement operation; andthe method further comprises:storing the signals read from the pixels during the first measurement operation;operating the pixels of the imaging array during a second measurement operation;reading signals from the pixels during the second measurement operation through the readout circuit of the imaging array; andcomparing the signals read from the pixels during the second measurement operation to the signals read from the pixels during the first measurement operation; andpositively shifting the threshold voltages of the transistors in response to a difference between the signals read from the pixels during the first measurement operation and the signals read from the pixels during the second measurement operation.

19. The method of claim 18, wherein:
positively shifting the threshold voltages of the transistors in response to the difference between the signals read from the pixels during the first measurement operation and the signals read from the pixels during the second measurement operation comprises positively shifting the threshold voltages of the transistors multiple times before reading signals from the pixels during a third measurement operation.

20. A system, comprising:
an x-ray source configured to generate x-rays;a detector disposed to receive the x-rays, the detector comprising:an imaging array including a plurality of pixels and row select lines, each pixel including a transistor coupled to a corresponding one of the row select lines;a row driver coupled to the row select lines;a readout circuit coupled to the imaging array; anda control circuit configured to:operate the pixels during a measurement operation;read signals from the pixels during the measurement operation through the readout circuit; andpositively shift threshold voltages of the transistors in response to the signals from the pixels.
